(19) United States
(12) Patent Application Publication
(10) Pub. No.: US 2009/0226090 A1
(43) Pub. Date: Sep. 10, 2009

(54) Information processing system, information processing apparatus, information processing method, and storage medium

(76) Inventor: Kunio OKITA, Kanagawa (JP)

Correspondence Address: HARNESS, DICKEY & PIERCE, P.L.C., P.O. BOX 8910, RESTON, VA, 20195, US

(21) Appl. No.: 12/382,025

(22) Filed: Mar. 6, 2009

(30) Foreign Application Priority Data
Mar. 6, 2008 (JP) 2008-057033

(51) Int. Cl. G06K 9/00

(52) U.S. Cl. 382/187

(57) ABSTRACT

A disclosed information processing system includes an input unit configured to input a file or an image of a form; an entry field obtaining unit configured to extract entry fields of the form from the input file or image; a label name obtaining unit configured to obtain label names of the extracted entry fields from characters or symbols in the form, the label names indicating information to be entered in the entry fields; a style information table storing unit configured to store a style information table that contains style information of the entry fields in association with the label names; a style information obtaining unit configured to search the style information table based on the obtained label names to obtain the style information of the entry fields; and an entry field definition output unit configured to output an entry field definition list including the entry fields, the label names, and the style information.

### BACKGROUND OF THE INVENTION

1. Field of the Invention

A certain aspect of the present invention relates to an information processing system, an information processing apparatus, an information processing method, and a storage medium.

2. Description of the Related Art

There are known systems that scan a paper form to obtain an image of the form and process information in entry fields predefined on the form with an optical character reader (OCR).

Such a system preferably has a function to check information written in the entry fields of a form in addition to a function to accurately determine the positions of the entry fields. Without a function to check information in the entry fields, the system cannot detect mistakes made by users or errors in the OCR process. This in turn reduces the reliability of the system.

To check information written in entry fields, a system needs information (hereafter called style information) on the characteristics of information to be written in the entry fields in addition to the positional information of the entry fields. The style information may include types of characters or values to be written in entry fields (for example, types of characters include “numeral”, “hiragana”, and “kanji” when Japanese language is used to enter information) and limits on the characters or values that can be entered in the entry fields (for example, a number is limited to a value less than or equal to 30). Thus, style information defines types of characters to be written and the ranges of the characters. For example, if a character string “age” is associated with an entry field, “numeral” is selected as the character type of the entry field and the number is limited to a positive value below 150 because the number is supposed to represent the age of a person.

Meanwhile, setting positional information and style information for entry fields is troublesome and generates much workload and therefore, there is a demand for a system or mechanism to automatically set the positional and style information.

For example, patent document 1 discloses a form field attribute generation system, a form field attribute generation method, and a form field attribute generation program.

The disclosed form field attribute generation system includes an image input unit for inputting a form image including field images and character images by optically scanning an original form prepared in advance, a recognition unit for recognizing fields and characters in the form image input by the image input unit and outputting field data and character data, a display unit for displaying a form image where the field data and the character data are associated with each other, a field selecting unit for selecting a field in the form image displayed by the display unit, and an attribute information generating unit for generating attribute information of the field selected by the field selecting unit based on item definition data corresponding to the selected field.

More specifically, when a user selects an area corresponding to a field of the displayed form image, an OCR form generating/editing apparatus 2 of the system generates field item attribute information based on image data in the selected area or a nearby area.

Also, patent document 2 discloses a field information generation program, a field information generation method, and an electronic form screen generating apparatus.

Field information generation methods used in conventional electronic form screen generating apparatuses do not provide a function to automatically generate field information corresponding to character entry fields represented by underlines on a paper form. To improve the efficiency in generating field information, patent document 2 proposes a program that performs a field information generation method for automatically generating field information of character entry fields represented by underlines on a paper form. The field information generation method includes a separate horizontal line extracting step of extracting separate horizontal lines based on a character/line database containing information on characters and lines on paper forms and a field candidate generating step of generating field candidates defined by lower-left coordinates and widths of fields based on the extracted separate horizontal lines.

Although related-art technologies as described above provide functions to automatically obtain positional information and label names of entry fields, they do not provide a function to automatically set style information of entry fields.

[Patent document 1] Japanese Patent Application Publication No. 2005-044256

[Patent document 2] Japanese Patent Application Publication No. 2003-323580

### SUMMARY OF THE INVENTION

Aspects of the present invention provide an information processing system, an information processing apparatus, an information processing method, and a storage medium that solve or reduce one or more problems caused by the limitations and disadvantages of the related art.

According to an aspect of the present invention, an information processing system includes an input unit configured to input a file or an image of a form; an entry field obtaining unit configured to extract entry fields of the form from the input file or image; a label name obtaining unit configured to obtain label names of the extracted entry fields from characters or symbols in the form, the label names indicating information to be entered in the entry fields; a style information table storing unit configured to store a style information table that contains style information of the entry fields in association with the label names; a style information obtaining unit configured to search the style information table based on the obtained label names and thereby to obtain the style information of the entry fields corresponding to the label names; and an entry field definition output unit configured to output an entry field definition list including the entry fields, the label names, and the style information.

According to another aspect of the present invention, an information processing method includes the steps of inputting a file or an image of a form; extracting entry fields of the form from the input file or image; obtaining label names of the extracted entry fields from characters or symbols in the form, the label names indicating information to be entered in the entry fields; searching a style information table based on the obtained label names and thereby obtaining style information of the entry fields corresponding to the label names; and outputting an entry field definition list including the entry fields, the label names, and the style information.

### BRIEF DESCRIPTION OF THE DRAWINGS

FIG. 1 is a drawing illustrating an exemplary process in an information processing system according to a first embodiment of the present invention;

FIG. 2 is a block diagram illustrating an exemplary configuration of an information processing system according to the first embodiment of the present invention;

FIG. 3 is a drawing illustrating front and rear label areas of entry fields with horizontal and vertical writing directions;

FIG. 4 is a drawing used to describe a process of obtaining a label name of an entry field where a label area table is selected based on the writing direction of the entry field;

FIG. 5 is a sequence chart used to describe operations of respective components of an information processing system according to an embodiment of the present invention;

FIG. 6 is a drawing illustrating an exemplary process in an information processing system according to a second embodiment of the present invention;

FIG. 7 is a block diagram illustrating an exemplary configuration of an information processing system according to the second embodiment of the present invention; and

FIG. 8 is a sequence chart used to describe operations of components of the information processing system that are added in the second embodiment.

### DESCRIPTION OF THE PREFERRED EMBODIMENTS

Preferred embodiments of the present invention are described below with reference to the accompanying drawings.

First, general concepts of an information processing system according to embodiments of the present invention are described.

An information processing system according to embodiments of the present invention inputs a vector file (an electronic file) of a form (vector form file) or obtains a raster image of a paper form (raster form image) by scanning the paper form, extracts lines and data in the vector form file or the raster form image, and outputs positional information of entry fields in the form and style information that is metadata regarding the entry fields. The style information may include label names of the entry fields, types of characters to be entered in the entry fields (input character types), and limits on values that can be input to the entry fields (input limits). In the present application, “characters” may include characters and symbols of any languages that can be processed or read by a computer. For example, “characters” may include kanji (including Chinese numerals), hiragana, katakana, numerals, and symbols in the Japanese language as well as characters and symbols, such as alphabets, in other languages.

The information processing system according to embodiments of the present invention extracts positional information of entry fields and character information from a form. The information processing system associates the extracted positional information of the entry fields with the character information and thereby obtains label names of the entry fields. The label names are character information that tells the user the types of information to be entered in the entry fields. For example, if an information item “NAME ______” is included in (an entry field of) a form, the user can understand that a name is to be written in the underlined space. The user easily understands, by experience, the relationship between the character string “name” and the underlined space (entry field) that follows. In other words, the user can determine the type of information to be written in the underlined space based on the character string “name” In this case, the information processing system uses (or defines) the character string “name” as the label name of the entry field.

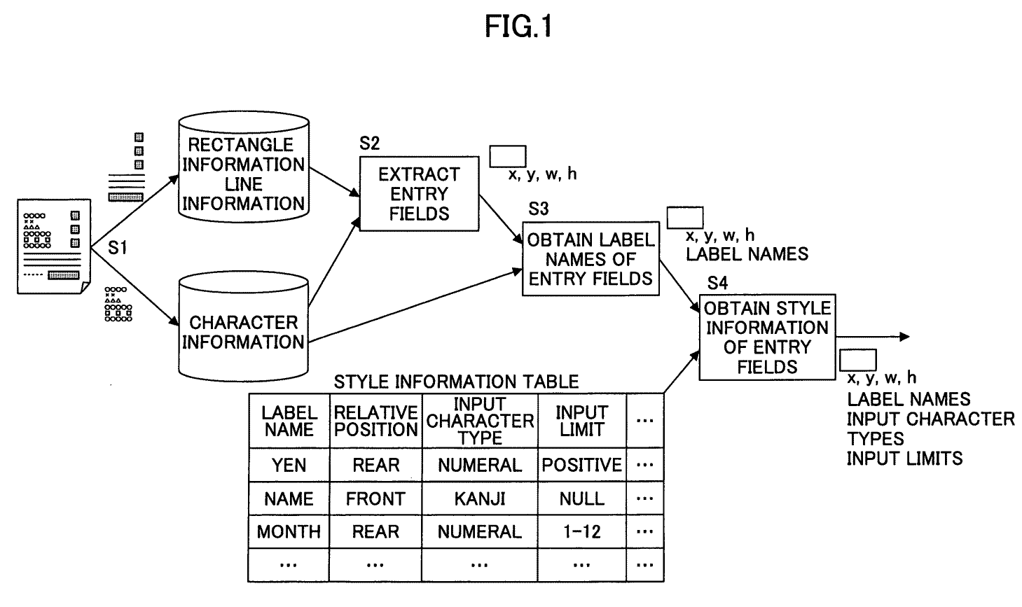

Next, the information processing system searches a style information table stored in the system based on the label name of the entry field to obtain style information for the entry field. In the style information table, label names, their positions, input character types, input limits, and so on are associated with each other (see “style information table” in FIG. 1). The information processing system searches the style information table with a label name of an entry field and the position of the label name to obtain an input character type and an input limit corresponding to the label name and associates the obtained character type and the input limit with the entry field. For example, assuming that there is an entry field with a label name “age”, the information processing system searches the style information table with the label name “age”, thereby determines that the input character type of the entry field is “numeral” and the input limit is “greater than or equal to 20” (age greater than or equal to 20 years), and associates the determined information with the entry field.

Through the process as described above, the information processing system outputs positional information and label names of entry fields and the corresponding style information obtained from the style information table. Also, the information processing system may be configured to allow the user to check the output style information and correct errors in the style information, and to update the style information table based on the user correction. The update of the style information table is preferably performed by supervised reinforcement learning.

### First Embodiment

### Information Processing System of First Embodiment

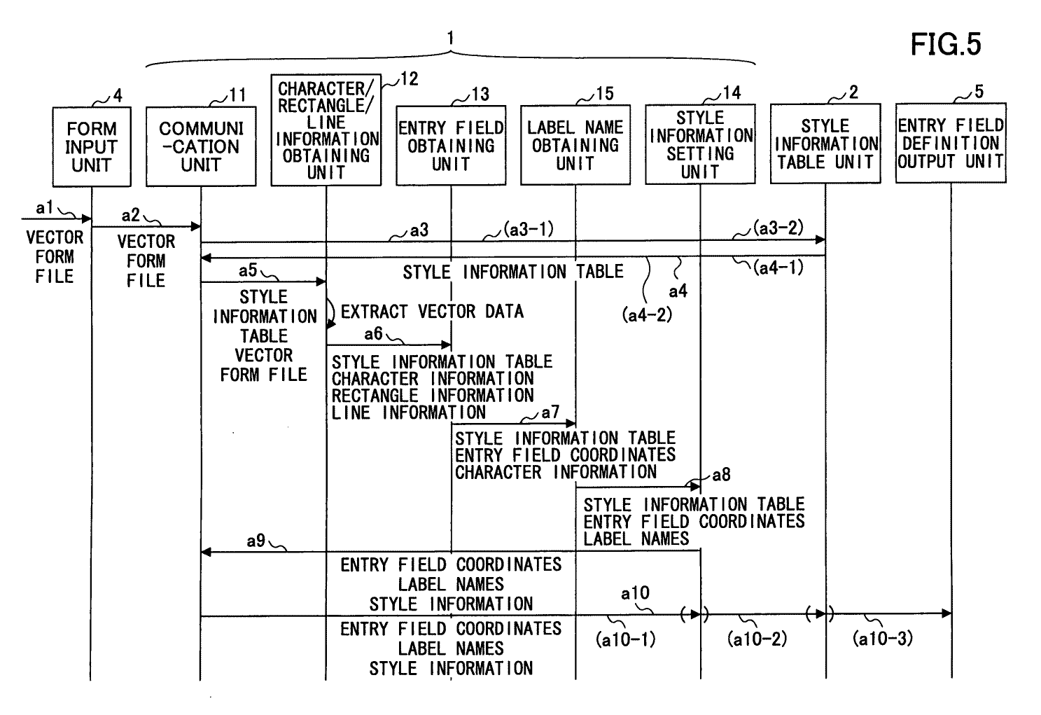

In the descriptions below, it is assumed that a vector form file is input to an information processing system (see a1 in FIG. 5). A vector form file includes information on rectangles, lines, and characters as vector data. For example, the portable document format (PDF) may be used for vector form files. Although not described in the examples below, an information processing system of a first embodiment can also extract rectangles and lines and obtain characters by an OCR process from a raster form image. In other words, the information processing system can obtain information from vector form files as well as raster form images and process the obtained information in substantially the same manner.

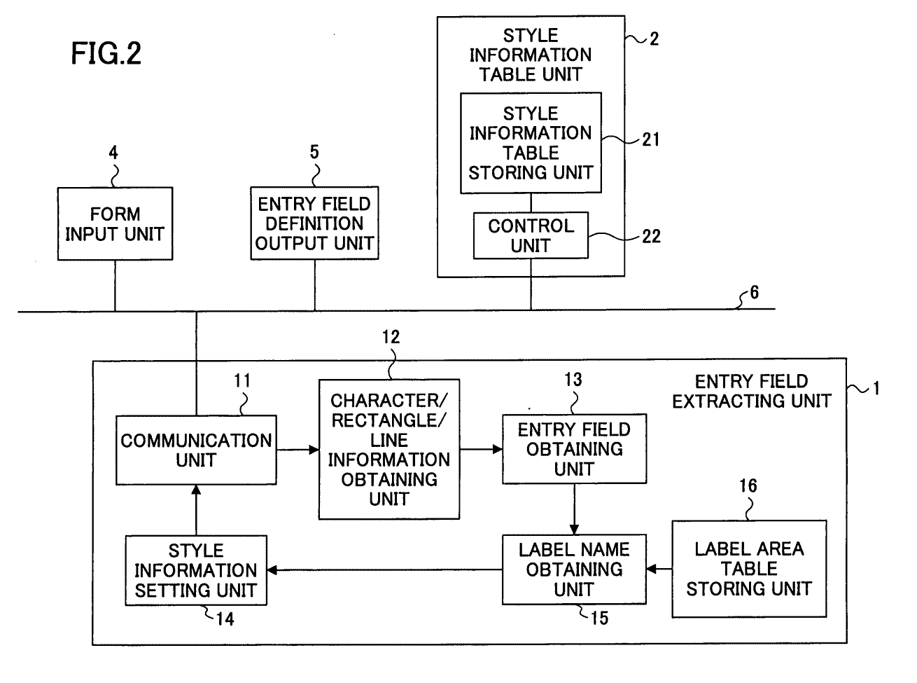

FIG. 1 is a drawing illustrating an outline of a process in the information processing system of the first embodiment. FIG. 2 is a block diagram illustrating an exemplary configuration of the information processing system according to the first embodiment. FIG. 5 is a sequence chart illustrating communications between components (functional blocks) of the information processing system shown in FIG. 2.

First, an outline of a process in the information processing system of the first embodiment is described with reference to FIGS. 1 and 5.

The information processing system downloads (or receives) a vector form file via, for example, the Internet (a1 and a2 in FIG. 5). Next, the information processing system obtains rectangle information, line information, and character information represented by vector data from the received vector form file (S1 in FIG. 1 and a1 through a5 in FIG. 5). In the example shown in FIG. 1, the rectangle information and the line information are stored in one storage unit (first storage unit) and the character information is stored in a separate storage unit (second storage unit). Alternatively, the rectangle and line information and the character information may be stored in separate storage areas (first and second storage areas) in the same storage unit or device (computer). In the first embodiment, a character/rectangle/line information obtaining unit 12 functions as a storage unit. As shown in FIG. 5, information items in a vector form file input via a communication unit 11 (a2 in FIG. 5) are stored in a style information table (as shown in FIG. 1) in a style information table unit 2 by the character/rectangle/line information obtaining unit 12, an entry field obtaining unit 13, a style information setting unit 14, and a label name obtaining unit 15 in an entry field extracting unit (entry field extraction application) 1. Alternatively, information items in a vector form file may be stored in advance as a style information table in the style information table unit 2.

Based on the input vector form file and the information items stored in the style information table, the entry field extracting unit 1 extracts information on entry fields (entry field information) (S2 in FIG. 1 and a5 through a7 in FIG. 5). In this embodiment, the entry field information is extracted from a set of the rectangle information, the line information, and the character information obtained as described above (a7 in FIG. 5). The entry field information includes positional information of the entry fields represented, for example, by coordinates (x, y), width (w), and height (h) (a7 in FIG. 5).

Next, the entry field extracting unit 1 obtains label names of the entry fields and relative positions of the label names with respect to the entry fields from the character information and the positional information (S3 in FIG. 1 and a8 in FIG. 5). In the style information table, label names are associated with their relative positions as shown in FIG. 1.

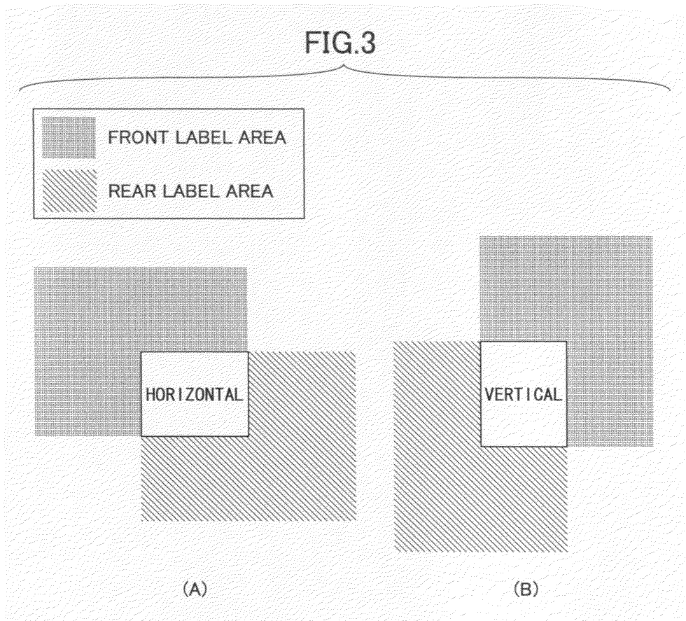

In the first embodiment, a position field in the style information table may contain either “front” or “rear” as the relative position of a label name. According to the exemplary style information table of FIG. 1, label names “yen” and “month” are positioned in the rear of entry fields and a label name “name” is positioned in front of an entry field. The entry field extracting unit 1 obtains either “front” or “rear” as the relative position of each of the label names. For example, when an entry field has a horizontal writing direction, “front” indicates a position above or to the left of the entry field and “rear” indicates a position below or to the right of the entry field (see FIG. 3). The relative position of a label name with respect to an entry field may be represented by one of the positional parameters “above”, “below”, “left”, and “right”. However, after the writing direction, “horizontal” or “vertical”, of an entry field is determined as described later, the relative position of a label name can be represented by “front” or “rear”. That is, if the writing direction of an entry field is determined to be “horizontal”, the relative position of a label name can be represented by “front” or “rear” instead of “left” or “right” with respect to the information to be written in the entry field, and the positional parameters “above” and “below” are not used. The entry field extracting unit 1 searches the style information table based on the obtained label names and the relative positions of the label names.

The entry field extracting unit 1 obtains style information corresponding to the label names and the relative positions from the style information table (S4 in FIG. 1 and a9 in FIG. 5). For example, the entry field extracting unit 1 obtains input character types and input limits for the entry fields. The style information table includes label names of entry fields, relative positions of the label names, input character types, and input limits (see “style information table” in FIG. 1).

Thus, the entry field extracting unit 1 obtains style information including label names, input character types, and input limits for the respective entry fields and outputs the style information (a10 in FIG. 5).

### Internal Configuration of System

FIG. 2 is a block diagram illustrating an exemplary configuration of the information processing system of the first embodiment.

The information processing system of the first embodiment includes functional blocks as shown in FIG. 2.

[Form Input Unit 4]

A form input unit 4 is an interface for a user to input a vector form file or a raster form image. For example, the form input unit 4 is implemented by an application program for receiving a vector form file or converting a raster form image input by an image reading device (scanner) into digital data. In the first embodiment, as described above, the form input unit 4 downloads (or receives) a vector form file (form data) via, for example, the Internet (a1 in FIG. 5).

[Entry Field Definition Output Unit 5]

An entry field definition output unit 5 is an interface (e.g., a graphical user interface: GUI) for outputting a list of entry field definitions (entry field definition list) obtained by processing a vector form file input by the user.

[Style Information Table Unit 2]

The style information table unit 2 includes a style information table storing unit 21 for storing a style information table and a control unit 22.

[Control Unit 22]

The control unit 22 of the style information table unit 2 writes information into at least a part of the style information table in the style information table storing unit 21, reads the style information table, and extracts a part of the style information table. The control unit 22 may also be configured to update the style information table based on correction information. In this sense, the control unit 22 may also be called a style information table updating unit.

In the first embodiment, the control unit 22 obtains the style information table from the style information table storing unit 21 of the style information table unit 2 (a3 in FIG. 5) and sends the obtained style information table to the entry field extracting unit (entry field extraction application) 1 (a4 in FIG. 5). The control unit 22 may be configured to search the style information table based on a search query sent from the entry field extracting unit 1 and to return a part of the style information table matching the search query (a3 and a4 in FIG. 5).

[Style Information Table Storing Unit 21]

The style information table storing unit 21 of the style information table unit 2 stores input style information as the style information table.

For example, as shown in table 1, the style information table in the style information table storing unit 21 may contain style information including label names of entry fields, positional information (relative positions) of the label names, input character types of the entry fields, and input limits of the entry fields.

TABLE 1

| | | Input | |
|---|---|---|---|
| | Relative | character | |
| Label name | position | type | Input limit |
| year | rear | numeral | 2000 or |
| | | | greater |
| month | rear | numeral | 1-12 |
| name | front | kanji | null |
| pronunciation | front | hiragana | null |
| . . . | . . . | . . . | . . . |

In the input limit field shown in table 1, “null” indicates that there is no limit on the value that can be input to the corresponding entry field.

The entry field extracting unit (entry field extraction application) 1 includes functional blocks as described below.

[Communication Unit 11]

The communication unit 11 of the entry field extracting unit 1 obtains the style information table from the style information table storing unit 21 of the style information table unit 2 and sends and receives information to and from other functional blocks.

Also, the communication unit 11 receives a vector form file from the form input unit 4 (a2 in FIG. 5) and sends the vector form file and the obtained style information table to the character/rectangle/line information obtaining unit 12 (a3 through a5 in FIG. 5).

Further, the communication unit 11 obtains an entry field definition list from the style information setting unit 14 (a9 in FIG. 5) and sends the entry field definition list to the entry field definition output unit 5 (a10 in FIG. 5).

[Character/Rectangle/Line Information Obtaining Unit 12]

The character/rectangle/line information obtaining unit 12 of the entry field extracting unit 1 receives the vector form file and the style information table from the communication unit 11 and obtains character information, rectangle information, and line information represented by vector data from the received vector form file (a5 in FIG. 5) and sends the obtained character, rectangle, and line information and the style information table to the entry field obtaining unit 13 (a6 in FIG. 5).

[Entry Field Obtaining Unit 13]

The entry field obtaining unit 13 of the entry field extracting unit 1 receives the character, rectangle, and line information represented by vector data and the style information table from the character/rectangle/line information obtaining unit 12 (a6 in FIG. 5) and extracts coordinates of entry fields (may include widths and heights of the entry fields, and may be simply referred to as “entry fields”). The entry field obtaining unit 13 sends the extracted coordinates of the entry fields, the style information table, and the character information to the label name obtaining unit 15 (a7 in FIG. 5).

Any known algorithm may be used to extract coordinates of entry fields. Descriptions of such an algorithm are omitted here.

[Label Name Obtaining Unit 15]

The label name obtaining unit 15 of the entry field extracting unit 1 receives the coordinates of the entry fields, the character information represented by vector data, and the style information table from the entry field obtaining unit 13 (a7 in FIG. 5) and also receives a label area table from a label area table storing unit 16. The label area table defines label areas from which label names are to be obtained.

The label name obtaining unit 15 obtains label names of the entry fields from the character information received from the entry field obtaining unit 13, and sends the coordinates of the entry fields, the obtained label names of the entry fields, relative positions of the label names with respect to the entry fields (“front” and “rear” in this embodiment), and the style information table to the style information setting unit 14 (a8 in FIG. 5).

The information processing system of this embodiment can process a language (such as Japanese) where characters are written both in the horizontal direction (e.g., from left to right) and in the vertical direction (from top to bottom).

In this embodiment, as shown in FIG. 3, if an entry field has a horizontal writing direction, an area above or to the left of the entry field is defined as a “front label area” from which a front label name can be obtained and an area below or to the right of the entry field is defined as a “rear label area” from which a rear label name can be obtained. Meanwhile, if an entry field has a vertical writing direction, an area above or to the right of the entry field is defined as a “front label area” and an area below or to the left of the entry field is defined as a “rear label area”.

The sizes of the label areas are predefined in the label area table as exemplified by table 2.

TABLE 2
Exemplary label area table for horizontal entry field

| | | |
|---|---|---|
| Type | Upper left | Lower right |

| | | | | |
|---|---|---|---|---|
| Front label | x1 − 100 | y1 + 100 | x2 | y2 |
| area | | | | |
| Rear label | x1 | y1 | x2 + 50 | y2 − 50 |
| area | | | | |

In table 2, x1 indicates the x coordinate of the upper left corner of an entry field, y1 indicates the y coordinate of the upper left corner, x2 indicates the x coordinate of the lower right corner, and y2 indicates the y coordinate of the lower right corner. The label areas are defined relative to the position (coordinates) of the entry field. However, areas overlapping the entry field are excluded from the label areas. In the first embodiment, the label areas are defined as rectangular areas. However, the label areas may have any other shape.

Meanwhile, when a language such as Arabic where characters are written from right to left is used, the front and rear label areas in the above example are inverted. Thus, definitions of label areas may vary depending on the language to be used. Therefore, the information processing system preferably includes label area tables defining label areas for respective languages and is preferably configured to determine the language(s) being used (language of label names) based on characters around entry fields and to select a label area table corresponding to the determined language. Alternatively, multiple sets of label area definitions may be provided and classified in one label area table so that an appropriate set of label area definitions can be selected and extracted from the label area table based on the language being used. For example, each set of label area definitions may be associated with a group of languages that use the same set of label area definitions. This configuration makes it possible to reduce time needed by a control unit of a system or an apparatus to select and extract label area definitions. This in turn makes it possible to allocate the extra time obtained by reducing the time needed to select and extract label area definitions to other operations such as data checking and thereby makes it possible to improve the performance of the system or apparatus.

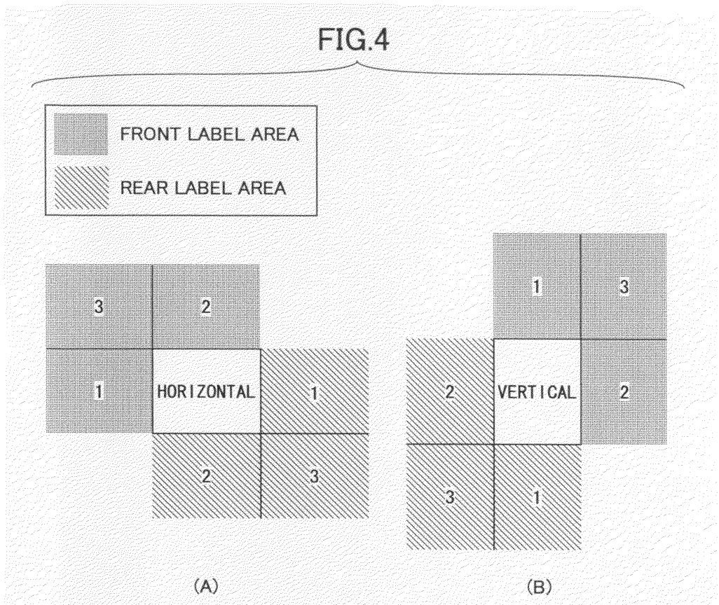

In the first embodiment, the writing direction of an entry field is determined based on the writing direction of characters around the entry field during the process of obtaining a label name of the entry field and a label area table corresponding to the determined writing direction of the entry field is selected to obtain the sizes of label areas. Then, as shown in FIG. 4, each of the label areas are divided into three sub-areas by lines that extend from sides of the entry field and are two times longer than the corresponding sides of the entry field. Priority levels are given to the sub-areas (in FIG. 4, priority levels are indicated by numbers) and characters in the sub-areas are searched for in the order of the priority levels. If characters are found in one of the sub-areas, the search is stopped at the sub-area (remaining sub-areas are not searched) and the found characters are defined as the label name of the entry field. The writing directions of entry fields can be determined, for example, based on directions of characters in the results of an OCR process performed on a form.

Meanwhile, if a label name of an entry field indicates that the entry field is an address field, it can be assumed that at least two types of characters are entered in the entry field. For example, in the case of the Japanese language, an address includes Japanese characters (such as kanji and kana) and numbers in the order mentioned. In the case of English, an address includes numbers and alphabets in the order mentioned. Thus, if a label name of an entry field indicates that the entry field is an address field, it is possible to determine that two (or more) types of characters (e.g., alphabets and numbers) are used for the entry field. To put it the other way around, if an entry field includes numbers and other characters, it is possible to determine that the entry field is an address field and to use “Address” as its label name.

[Label Area Table Storing Unit 16]

The label area table storing unit 16 of the entry field extracting unit 1 stores label area tables.

[Style Information Setting Unit 14]

The style information setting unit 14 of the entry field extracting unit 1 receives coordinates of entry fields, label names of the entry fields, relative positions of the label names with respect to the entry fields, and the style information table from the label name obtaining unit 15 (a8 in FIG. 5). Also, the style information setting unit 14 searches the style information table based on the label names of the entry fields and their relative positions and thereby obtains input character types and input limits of the entry fields. Further, the style information setting unit 14 sends the coordinates of the entry fields, the label names of the entry fields, the input character types, and the input limits to the communication unit 11 as an entry field definition list (a9 in FIG. 5).

In the first embodiment, the entry field extracting unit 1 obtains the entire style information table and extracts input character types and input limits for the respective entry fields from the style information table based on the label names and the relative positions of the label names with respect to the entry fields. Alternatively, the entry field extracting unit 1 may be configured to send a search query via the communication unit 11 to the style information table unit 2 and to receive only the search results (style information corresponding to the entry fields).

The entry field definition list output from the style information setting unit 14 has a data structure as exemplified in table 3 below.

TABLE 3

| | | | | | Input | |
|---|---|---|---|---|---|---|
| | | Width | Height | Label | character | Input |
| x | y | (w) | (h) | name | type | limit |
| 10 | 10 | 80 | 30 | name | kanji | null |
| 10 | 100 | 30 | 30 | year | numeral | 2000 or |
| | | | | | | greater |
| 10 | 150 | 30 | 30 | month | numeral | 1-12 |
| . . . | . . . | . . . | . . . | . . . | . . . | . . . |

The entry field extracting unit 1 (specifically, the communication unit 11) and the style information table unit 2 of the information processing system of the first embodiment may be connected, for example, via a bus or a communication line such as a local area network (LAN). In other words, the functional blocks shown in FIG. 2 may be electrically connected via a communication line to form a system, or may be connected wirelessly or via a data line such as a USB to form an apparatus (e.g., a computer).

For example, the entry field extracting unit 1, the style information table unit 2, the form input unit 4, and the entry field definition output unit 5 may be connected via a communication line. Alternatively, the form input unit 4 and the entry field definition output unit 5 may be included in the entry field extracting unit 1 or in the style information table unit 2. Thus, the functional blocks (components) shown in FIG. 2 may be connected flexibly to form a system. Also, the entry field extracting unit 1, the style information table unit 2, the form input unit 4, and the entry field definition output unit 5 may be integrated in one apparatus. The information processing system of the first embodiment may also be implemented as program code for causing a computer to function as the functional blocks shown in FIG. 2 (or FIG. 5). Also, the information processing system of the first embodiment may be, at least partially, composed of an entry field extracting unit implemented by program code executed by a computer, the style information table unit 2, the form input unit 4, and the entry field definition output unit 5 that are connected to each other via a network. Further, the information processing system of the first embodiment may be implemented as program code (stored in a storage medium) for causing a computer to function as an information processing apparatus including the entry field extracting unit 1, the style information table unit 2, the form input unit 4, and the entry field definition output unit 5. In the first embodiment, the entry field extracting unit 1, the style information table unit 2, the form input unit 4, and the entry field definition output unit 5 communicate with each other via a communication path 6 shown in FIG. 2. When the functional blocks (components) are integrated in one apparatus, a bus may be used as the communication path 6 and information may be sent between the functional blocks as indicated by arrows a3, a4, and a10 in FIG. 5. Meanwhile, when the entry field extracting unit 1, the style information table unit 2, the form input unit 4, and the entry field definition output unit 5 are provided separately in an information processing system, a network may be used as the communication path 6. In this case, information may be sent between the functional blocks as indicated by arrows a3-1, a3-2, a4-1, a4-2, a10-1, a10-2, and a10-3 in FIG. 5.

### Second Embodiment

### Outline of System

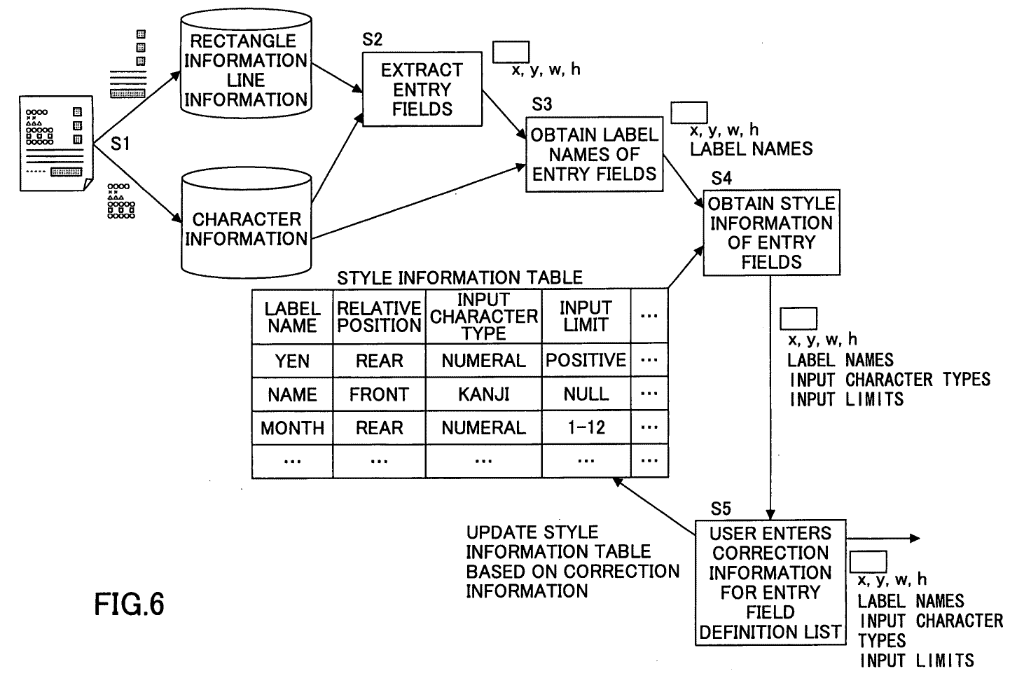

Next, an information processing system according to a second embodiment of the present invention is described. Below, differences between the first and second embodiments are mainly discussed. FIG. 6 is a drawing illustrating an exemplary process in the information processing system of the second embodiment. In the second embodiment, as in the first embodiment, it is assumed that a vector form file is input to the information processing system.

Steps S1 through S4 in FIG. 6 are substantially the same as those in FIG. 1 and therefore their descriptions are omitted here.

In the second embodiment, step S5 is added after step S4. In step S5, the user checks the style information of entry fields (or the entry field definition list) obtained in step S4. Step D5 preferably includes a step, performed by the user, of entering correction information. Further, the process preferably includes a step of updating the style information table by learning (preferably by reinforcement learning) according to the correction information entered by the user. Thus, the information processing system of the second embodiment obtains style information including label names, input character types, and input limits for respective entry fields and outputs the obtained style information (preferably on a GUI for user review).

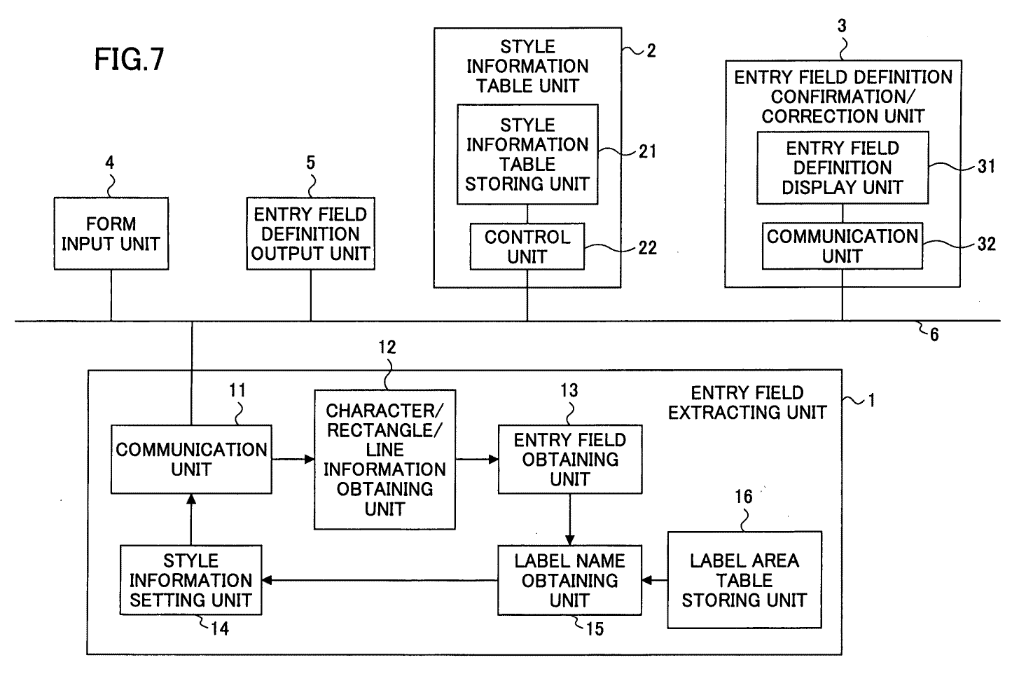

FIG. 7 is a block diagram illustrating an exemplary configuration of the information processing system according to the second embodiment. In the second embodiment, as is evident by comparing the system configurations of FIGS. 2 and 7, an entry field definition confirmation/correction unit 3 is added to the system configuration of the first embodiment.

Other components (the entry field extracting unit 1, the style information table unit 2, the form input unit 4, and the entry field definition output unit 5) of the information processing system of the second embodiment are substantially the same as those of the information processing system of the first embodiment.

### Difference in Internal Configuration of System

[Entry Field Definition Confirmation/Correction Unit (Entry Field Definition Confirmation/Correction Application) 3]

As described above, the information processing system of the second embodiment includes the entry field definition confirmation/correction unit 3 in addition to the components of the information processing system of the first embodiment. The entry field definition confirmation/correction unit 3 includes an entry field definition display unit 31 and a communication unit 32.

[Communication Unit 32]

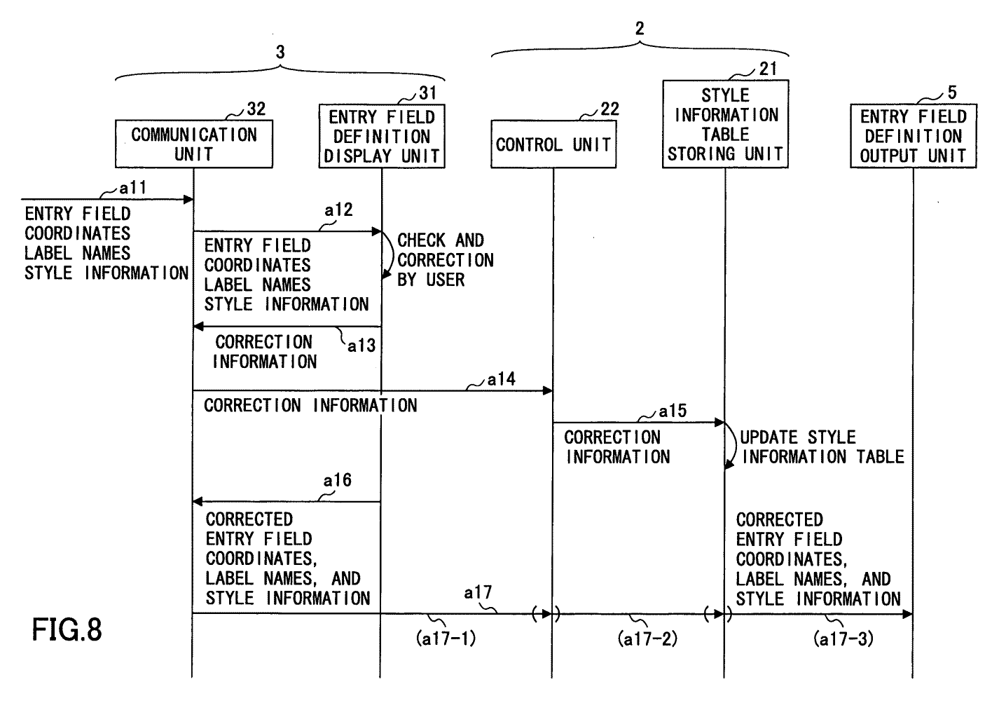

The communication unit 32 of the entry field definition confirmation/correction unit 3 receives an entry field definition list from the entry field extracting unit 1 (a11 in FIG. 8) and sends the entry field definition list to the entry field definition display unit 31 (a12 in FIG. 8).

When the user enters correction information for the entry field definition list, the entry field definition display unit 31 sends the correction information to the style information table unit 2 (a13 through a15 in FIG. 8).

The entry field definition display unit 31 also sends the entry field definition list checked or corrected by the user to the entry field definition output unit 5 (a17 in FIG. 8).

[Entry Field Definition Display Unit 31]

The entry field definition display unit 31 of the entry field definition confirmation/correction unit 3 receives an entry field definition list via the communication unit 32 from the entry field extracting unit 1 and displays the entry field definition list for the user (a11 and a12 in FIG. 8).

The user checks the displayed entry field definition list and corrects the entry field definition list if necessary.

The corrections on the entry definitions (correction information) are input via the entry field definition display unit 31 and are sent to the communication unit 32 (a13 in FIG. 8). In the second embodiment, the correction information includes label names, relative positions of the label names, input character types, and input limits.

When the user completes correcting (or checking) the entry field definition list, the entry field definition display unit 31 sends the corrected (or checked) entry field definition list to the communication unit 32.

The entry field definition list output from the entry field definition display unit 31 has a data structure as exemplified in table 4 below. The data structure is substantially the same as that shown in table 3.

TABLE 4

| | | | | | Input | |
|---|---|---|---|---|---|---|
| | | Width | Height | Label | character | Input |
| x | y | (w) | (h) | name | type | limit |
| 10 | 10 | 80 | 30 | name | kanji | null |
| 10 | 100 | 30 | 30 | year | numeral | 2000 or |
| | | | | | | greater |
| 10 | 150 | 30 | 30 | month | numeral | 1-12 |
| . . . | . . . | . . . | . . . | . . . | . . . | . . . |

### Information Flow Between Functional Blocks

The communication process between functional blocks from when a vector form file is input until when an entry field definition list is sent to the entry field definition confirmation/correction unit 3 is substantially the same as that of the first embodiment shown in FIG. 5 and therefore its descriptions are omitted here.

FIG. 8 is a sequence chart showing communications between the entry field definition confirmation/correction unit 3, which is employed in the second embodiment, the style information table unit 2, and the entry field definition output unit 5 that are performed to allow the user to check and correct the entry field definition list.

In step S4 shown in FIG. 1, the information processing system obtains input character types and input limits of entry fields from a style information table based on obtained label names of the entry fields and the relative positions of the label names. The style information table includes label names of entry fields, relative positions of the label names, input character types, and input limits.

Next, in the second embodiment, the user checks the style information of the entry fields and corrects the style information if necessary. The information processing system of the second embodiment is preferably configured to update the style information table by learning (preferably by reinforcement learning) according to correction information input by the user.

Then, the information processing system outputs the obtained style information (or the entry field definition list) including the label names, input character types, and input limits of the entry fields (a16 and a17 in FIG. 8).

More specifically, the communication unit 32 of the entry field definition confirmation/correction unit 3 receives an entry field definition list from the entry field extracting unit 1 (a11 in FIG. 8) and sends the entry field definition list to the entry field definition display unit 31 (a12 in FIG. 8).

The entry field definition display unit 31 receives the entry field definition list via the communication unit 32 from the entry field extracting unit 1 and displays the entry field definition list for the user (a12 in FIG. 8).

The user checks the displayed entry field definition list and corrects the entry field definition list if necessary.

The corrections on the entry definitions (correction information) are input via the entry field definition display unit 31 and are sent to the communication unit 32 (a13 in FIG. 8). The communication unit 32 sends the correction information to the control unit 22 of the style information table unit 2 (a14 in FIG. 8). The control unit 22 sends the correction information to the style information table storing unit 21 (a15 in FIG. 8), selects a corresponding style information table in the style information table storing unit 21, and updates the selected style information table based on the correction information (a15 in FIG. 8). For example, if the correction information is not present in the style information table, the control unit 22 adds the correction information to the style information table.

Also, the entry field definition display unit 31 sends the corrected entry field definition list to the communication unit 32 and the communication unit 32 sends the corrected entry field definition list to the entry field definition output unit 5 (a16 and a17 in FIG. 8).

As in the first embodiment, the functional blocks of the second embodiment shown in FIG. 7 may be connected via a bus or a communication line such as a LAN. Also, the functional blocks shown in FIG. 7 may be implemented as program code. Further, the second embodiment of the present invention may be implemented as program code (stored in a computer-readable storage medium such as a CD or a DVD) for performing an information processing method as shown by the sequence charts of FIGS. 5 and 8.

As described above, embodiments of the present invention provide an information processing system, an information processing apparatus, an information processing method, and a storage medium containing program code for causing a computer to perform the information processing method that make it possible to automatically set and output positional information and style information (metadata) of entry fields in a form.

The present invention is not limited to the specifically disclosed embodiments, and variations and modifications may be made without departing from the scope of the present invention.

The present application is based on Japanese Priority Application No. 2008-057033, filed on Mar. 6, 2008, the entire contents of which are hereby incorporated herein by reference.

What is claimed is:

1. An information processing system, comprising:
an input unit configured to input a file or an image of a form;
an entry field obtaining unit configured to extract entry fields of the form from the input file or image;
a label name obtaining unit configured to obtain label names of the extracted entry fields from characters or symbols in the form, the label names indicating information to be entered in the entry fields;
a style information table storing unit configured to store a style information table that contains style information of the entry fields in association with the label names;
a style information obtaining unit configured to search the style information table based on the obtained label names and thereby to obtain the style information of the entry fields corresponding to the label names; and
an entry field definition output unit configured to output an entry field definition list including the entry fields, the label names, and the style information.

2. The information processing system as claimed in claim 1, further comprising:
an entry field definition display unit configured to display the entry field definition list including the entry fields, the label names, and the style information to allow a user to check the entry field definition list and enter correction information to correct the entry field definition list if necessary; and
a style information table updating unit configured to update the style information table based on the correction information from the entry field definition display unit;
wherein the entry field definition output unit is configured to output the checked or corrected entry field definition list.

3. The information processing system as claimed in claim 1, further comprising:
a label area table storing unit configured to store a label area table including definitions of label areas from which the label names are to be obtained, the label areas being defined by coordinates relative to the entry fields;
wherein the label name obtaining unit is configured to obtain the definitions of the label areas from the label area table and to obtain the label names of the entry fields from the characters or symbols in the form based on the definitions of the label areas.

4. The information processing system as claimed in claim 3, wherein
the label area table includes the definitions of the label areas for respective relative positions of the label names with respect to the entry fields;
the label name obtaining unit is configured to obtain the label names and the relative positions of the label names based on the definitions of the label areas; and
the style information obtaining unit is configured to search the style information table based on the label names and the relative positions to obtain the style information of the entry fields.

5. The information processing system as claimed in claim 3, wherein
the label area table includes the definitions of the label areas for respective languages of the label names; and
the label name obtaining unit is configured to obtain the label names of the entry fields based on the definitions of the label areas corresponding to the languages of the label names.

6. The information processing system as claimed in claim 5, wherein the label name obtaining unit is configured to determine the languages of the label names based on character strings around the entry fields and to obtain the label names of the entry fields based on the definitions of the label areas corresponding to the determined languages.

7. The information processing system as claimed in claim 3, wherein
the label area table includes the definitions of the label areas for a vertical writing direction and a horizontal writing direction; and
the label name obtaining unit is configured to determine whether the entry fields have the vertical writing direction or the horizontal writing direction and to obtain the label names of the entry fields based on the definitions of the label areas corresponding to the determined writing directions.

8. An information processing apparatus comprising the input unit, the entry field obtaining unit, the label name obtaining unit, the style information table storing unit, the style information obtaining unit, and the entry field definition output unit of the information processing system of claim 1.

9. An information processing method, comprising the steps of:
inputting a file or an image of a form;
extracting entry fields of the form from the input file or image;
obtaining label names of the extracted entry fields from characters or symbols in the form, the label names indicating information to be entered in the entry fields;
searching a style information table based on the obtained label names and thereby obtaining style information of the entry fields corresponding to the label names; and
outputting an entry field definition list including the entry fields, the label names, and the style information.

10. The information processing method as claimed in claim 9, further comprising the steps of:
displaying the entry field definition list including the entry fields, the label names, and the style information to check the entry field definition list and enter correction information to correct the entry field definition list if necessary; and
updating the style information table based on the correction information;
wherein in the step of outputting the entry field definition list, the checked or corrected entry field definition list is output.

11. The information processing method as claimed in claim 9, further comprising the step of:
obtaining definitions of label areas, from which the label names are to be obtained, from a label area table, the label areas being defined by coordinates relative to the entry fields;
wherein the label names of the entry fields are obtained from the characters or symbols in the form based on the definitions of the label areas.

12. The information processing method as claimed in claim 11, wherein
the label area table includes the definitions of the label areas for respective relative positions of the label names with respect to the entry fields;
the label names are obtained together with the relative positions of the label names based on the definitions of the label areas; and
the style information of the entry fields is obtained by searching the style information table based on the label names and the relative positions.

13. The information processing method as claimed in claim 11 wherein
the label area table includes the definitions of the label areas for respective languages of the label names; and
the label names of the entry fields are obtained based on the definitions of the label areas corresponding to the languages of the label names.

14. The information processing method as claimed in claim 13, further comprising the step of:
determining the languages of the label names based on character strings around the entry fields;
wherein the label names of the entry fields are obtained based on the definitions of the label areas corresponding to the determined languages.

15. The information processing method as claimed in claim 11, wherein
the label area table includes the definitions of the label areas for a vertical writing direction and a horizontal writing direction; and
the label names of the entry fields are obtained based on the definitions of the label areas corresponding to the writing directions of the entry fields.

16. The information processing method as claimed in claim 10, wherein the style information table is updated by adding the entered correction information to the style information table if the correction information is not present in the style information table.

17. The information processing method as claimed in claim 10, wherein the style information table is updated by supervised learning according to the entered correction information.

18. A storage medium having program code embodied therein for causing an information processing system or an information processing apparatus to perform the information processing method of claim 9.
